(19) United States
(12) Patent Application Publication
(10) Pub. No.: US 2010/0030579 A1
(43) Pub. Date: Feb. 4, 2010

(54) Health Care Package

(76) Inventor: Pocham Dhauvan, Austin, TX (US)

Correspondence Address: Gooffrey Gellman, 14 Berkeley Pl. #3, Brooklyn, NY, 11217, US

(21) Appl. No.: 12/512,021

(22) Filed: Jul. 29, 2009

Related U.S. Application Data
(60) Provisional application No. 61/084,314, filed on Jul. 29, 2008.

(51) Int. Cl. G06Q 50/00; G06Q 10/00; G06Q 30/00; G06Q 40/00; G01C 21/00; H04L 9/32; G06F 15/16

(52) U.S. Cl. 705/3; 705/2; 701/300; 726/6; 709/206

(57) ABSTRACT

Various embodiments include methods and systems for providing packaged health care solutions.

The present application claims the benefit of priority of the following provisional patent application: U.S. Provisional Patent Application No. 61/084,314, filed Jul. 29, 2008, entitled “METHOD AND SYSTEM FOR PROVIDING A COMPREHENSIVE LOW COST PACKAGED HEALTH CARE SOLUTION FOR MEMBERS OF AN ASSOCIATION OR EMPLOYEES OF AN ORGANIZATION”, the entirety of which is incorporated by reference herein.

### BACKGROUND

The costs of medical treatment may be high in some countries. Such costs may be continuing to rise. As a result, spending on health care has increased in some places. According to an estimate, the cost of health insurance in America rose between 8.2% and 13.9% per year from 2000 to 2005. Some reports have indicated that rises in health care costs in the U.S. have outpaced rises in wages.

Increases in health insurance costs may have several adverse effects. For example, increasing insurance costs of employees of an organization may reduce the organization's competitiveness. According to an estimate, U.S. employers spent more than $350 billion on health insurance in 2005.

A possible way to address expensive health insurance and manage costly medical treatment is through health care outsourcing. In some countries, medical facilities may be available at lower costs than in other countries. Some countries may therefore have a cost advantage in providing health care services as compared to other countries with higher health care costs.

### SUMMARY

Various embodiments include methods and systems for providing packaged health care solutions to the members of an association. The association may have members from one or more countries. Some of the countries may have costs of health care that are at such a level as to drive residents of the countries to seek or desire lower cost health care. Such countries may be referred to as high health cost countries. A high health cost country may be held in contrast with one or more low health cost countries. A low health cost country may refer to a country where the quality of health care facilities are comparable to those of a particular high health cost country, but where the costs involved are lower than the costs at corresponding facilities in the high health cost country. India and Costa Rica, for example, may be considered as low health cost countries when held in contrast to the U.S.

In various embodiments, through a packaged health care solution, the members from a high health cost country may avail themselves of health care facilities in one or more corresponding low cost countries. The packaged health care solution may give the members access to world-class health facilities that are available globally. As a part of this packaged health care solution, comprehensive end-to-end medical, travel, concierge, and facilitation services may be provided to the members.

Methods and systems according to various embodiments may have the intelligence to personalize the user experience and suggest the best venues for identified medical procedures. Various embodiments may also suggest venues so as to reduce or minimize pricing. Doctor profiles, existing testimonials, images and videos of the hospitals and doctors for each chosen venue may be provided to the members.

In various embodiments, recommendations for pre- or post procedure tours may be given to members. The system may seamlessly integrate a health plan database, a patient database, a travel portal, and a virtual support network for the patient. The virtual support network may be designed to offer the ability for friends and family to sign up for secure interaction with a patient, to schedule the delivery of flowers to the patient, and to receive regular updates about the patient. It also may offer a provision for a local medical team (e.g., the primary physician of the patient, e.g., a physician in the home country of the patient, etc.) to engage with the patient and monitor the patient's condition and treatment. The contribution for this packaged health care solution may be collected from associations as a global provider access fee on per member per month basis. Payment for actual health care treatment may be made by a patient's health insurance provider, which may be a separate entity.

### BRIEF DESCRIPTION OF THE DRAWINGS

FIG. 1 is an exemplary diagram showing a system and its environment in accordance with various embodiments;

FIG. 2 is an exemplary block diagram of health benefit system in accordance with various embodiments;

FIG. 3 is an exemplary diagram depicting the Interaction module in accordance with various embodiments;

FIG. 4 is an exemplary diagram showing different services offered by the health benefit plan to members in accordance with various embodiments;

FIG. 5 is an exemplary diagram which illustrates the relationships between members of participating associations or organizations and managers appointed by health benefit system in accordance with various embodiments;

FIG. 6 is an exemplary flow chart which illustrates a process involved in implementing health benefit plan in accordance with various embodiments;

FIG. 7 is an exemplary diagram which illustrates comprehensive end-to-end services provided to members in accordance with various embodiments;

FIG. 8 is an exemplary flow chart describing a procedure for providing treatment to members in accordance with various embodiments.

### DETAILED DESCRIPTION

Various embodiments contemplate the provision of packaged healthcare services at reduced costs. For example, various embodiments contemplate the reduction of health care costs in some countries through the provision of health care services in other countries. Various embodiments include methods for providing healthcare service to members of an association and employees of an organization in a country of higher healthcare costs by off-shoring a component of the service to countries with lower healthcare costs.

Various embodiments include methods and systems for providing a low cost packaged health care solution for members of an association, such as employees of an organization. The packaged health care solution may be provided in high health cost countries like the US where the cost of health care may be undesirably high to some. As part of the packaged health care solution, the members may receive treatment in countries like India where the quality of health care facilities may be comparable to that in countries with higher healthcare costs, but where health care costs may be relatively low. Various embodiments may allow for substantial cost savings to the associations and their members. Also, various embodiments may be flexible and may include standalone embodiments or embodiments where a packaged health care solution may integrate with any existing insurance plan of the association.

In various embodiments, an association or organization may be self-insured or substantially self-insured. Accordingly, the association or organization may, on its own, cover the health care costs of its members. The association or organization may cover the health care costs of its members without the assistance of outside insurance companies, for example. According to various embodiments, an association or organization may enjoy substantial savings on paying for the health care of its members by offering to its members plans for receiving treatment overseas. The overseas treatments may occur in countries outside the home country of the association or organization, and may occur in countries with substantially lower health care costs.

As an association or organization may benefit from paying for health care received overseas, (e.g., outside the United States), the organization may encourage its members to enroll in health plans that cover procedures overseas but which do not cover similar procedures in the home country. For example, the association or organization may encourage its members to enroll in health plans that only cover non-emergency procedures, which would cost over $20,000 in the United State, when such procedures are performed in India or Thailand. The health plan would not cover non-emergency procedures costing over $20,000 if performed in the United States.

In some embodiments, a health plan (e.g., a health insurance plan) may be offered to a member wherein certain procedures are covered within a first country (e.g., within the US), and certain procedures are only covered outside of the first country (e.g., outside of the US). In various embodiments, a health plan may be offered where any procedure that would cost in excess of a given threshold in a first country (e.g., in the US) would only be covered if performed outside the first country (e.g., outside the US). In some embodiments, a health plan may be offered where any procedure that would cost in excess of a threshold amount in a first country (e.g., in the US), and is available at comparable quality (or at some other comparable metric) outside the first country, would only be covered outside the first country.

In some embodiments, a health plan includes a first component that covers care, treatment, and/or procedures within a first country (e.g., the US), and a second component that covers care, treatment and/or procedures outside of the first country. The first component may include treatments that cost less than a threshold amount in the first country (e.g., less than $15,000). The first component may also include emergency care, which may include care that must be provided immediately without allowing for time for the patient to travel outside of the first country. The first component may also include care which is not offered outside the first country. The first component may also include care which is not offered outside the first country at a quality that is comparable to the care offered within the first country. In some embodiments, the health plan includes a second component which covers certain procedures outside of a first country, and which only covers the procedures if performed outside of the first country. The second component may include procedures not encompassed by the first component (e.g., non-emergency procedures that would cost in excess of $15,000 in the first country, but could be performed at comparable quality outside of the first country).

As encouragement to its members for enrolling in such health plans, the association or organization may offer to its members one or more benefits, which may include: reduced insurance premiums, the elimination of insurance premiums, reduced co-pays, elimination of co-pays, reduced deductibles, elimination of deductibles, monetary payments to members, and any other benefits.

In some embodiments, an association or organization may offer to its members a dividend, monetary payment, or other consideration based on the savings enjoyed by the organization from the members' enrollment in health plans providing preferential coverage for overseas procedures (e.g., as described above). For example, based on members' enrollment in the health plans, the association or organization may save 50% of the amount it would otherwise require to provide health insurance to its members. Accordingly, the association or organization may return all or a portion of these savings to its members (e.g., to members enrolling in the health plans providing preferential coverage for overseas procedures). The savings may be returned in the form of cash dividends or other benefits. In some embodiments, e.g., if the association or organization is self-insured, then the organization may tally up the amounts actually saved from paying for treatment for members enrolled in the beneficial health plans. For example, if the organization has paid only $1 million total for treatments that would have cost $2 million total in the U.S., then the organization may return all or a portion of the $1 million savings to its members.

In some embodiments, a health plan offered to a member may cover health care costs for a particular illness both within a first country and outside the first country. However, health care costs outside the first country may be substantially lower than those within the first country. Thus, according to some embodiments, the party offering the health plan (e.g., an association; e.g., an insurance company) may offer incentives to the patient so as to encourage the patient to partake of care outside of the first country. These incentives may include paying the patient a portion of the amount saved in administering the care outside of the first country, reduction or elimination of co-pays, reduction or elimination of deductibles, and/or any other benefits.

In the present description, specific details are set forth in order to provide a thorough understanding of various embodiments. However, it will be apparent to a person of ordinary skill in the art, that various embodiments may be practiced without these specific details, or with additional details. Various aspects and features of example embodiments are described in detail hereinafter.

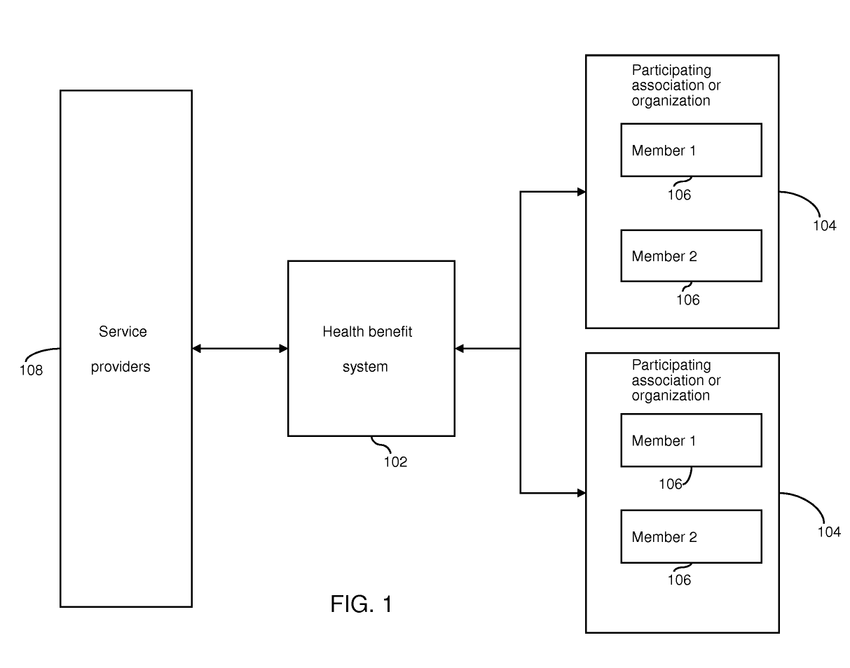

FIG. 1 shows an exemplary system and its environment in accordance with various embodiments. Hereinafter, the system is referred to as health benefit system 102. Health benefit system 102 may offer a health benefit plan to one or more participating associations or organizations 104. An association may refer to a group of individuals who voluntarily enter into an agreement to accomplish a purpose. Examples of association may include corporations, trade unions, merchant unions, employers and the like. Members 106 of participating associations or organizations 104 may be beneficiaries of the health benefit plan. The health benefit plan may offer medical services to members 106 of participating associations or organizations 104 at low cost. According to the health benefit plan, each of the members 106 may be charged a fixed amount per month. When a member 106 requires medical treatment, she may be provided with required medical services in a low health cost country along with end-to-end services like travel, accommodation, etc.

In various embodiments, a fee charged for a member need not be charged directly to that member. In various embodiments, an association or organization that offers a health plan (e.g., to its employees) may pay a fixed per-member per-month fee to the system (e.g., the health benefit system). The fee may be paid by the organization as a way to include the option of overseas health care for its members, and to thereby, for example, save money on insurance premiums and/or on medical costs. In various embodiments, the association or organization may collect insurance payments from its members, but the payments may be collected as part of an overall health insurance package, and need not specifically cover only the health benefit plan offered according to various embodiments. In other words, in various embodiments, a member may pay a single monthly insurance bill, and the association may, in turn separately pay both the health benefit system and an insurance company.

In some embodiments, a patient may choose whether or not to enroll in a health insurance plan or health plan which offers coverage for the overseas provision of medical care. Whether or not the patient chooses to enroll may effect any monthly (or other periodic) fees charged to the patient. For example, if the patient does choose to enroll, his monthly fees may be substantially lower than if he does not. If the patient does enroll, then he may agree to receive certain needed medical treatments overseas (or at least agree that such medical treatments will only be covered if received overseas).

In various embodiments, when a patient is given the choice to enroll in a plan that preferentially covers overseas treatment, the patient may be provided with an indication of overseas locations and/or facilities where treatment would be received, and may be provided various information about such facilities. Such information provided may include information about the doctors on staff, information about staff certification, information about success rates, information about local attractions, information about hygiene, and any other information that may be relevant to the patient's choice of whether or not to enroll.

In some embodiments, if a patient does enroll in a plan providing preferential overseas coverage, then the patient may be asked to submit medical records, e.g., to the health benefit system 102. The patient may be asked to give consent to provide such records and/or to provide such records directly.

In various embodiments, the cost of medical services may be provided by the insurance plan of an organization.

In various embodiments, the health benefit system 102 may receive an indication of a treatment required, and may subsequently determine options for providing the treatment. The health benefit system may determine, for example, which overseas facilities can provide the treatment. However, in various embodiments, the health benefit system 102 is not involved in determining which treatment is required. In some embodiments, the health benefit system 102 selects from among available facilities a subset of the facilities based on certain criteria. Criteria may include criteria provided by an association or organization, such as by an employer. The association may desire that the health benefit system preferentially list options that are the least expensive; that are closest to the association (e.g., closest to the place of work of the patient); that have good communications facilities (e.g., so the patient can periodically call into work); or that satisfy some other criteria. Thus, for example, based on employer input, the health benefit system 102 may list certain treatment options before other treatment options, may highlight certain treatment options, or may otherwise emphasize certain treatment options over other treatment options.

In various embodiments, the health benefit system may offer treatment options that include one or more optional or extra features or components. Extra features or components may include, for example, extra travel, extra accommodations, or anything beyond what is medically required. Such optional features may be flagged or otherwise indicated to a member. When selecting a treatment option which includes optional features, the member may thereby be made aware that such features would cost extra and would be his financial responsibility.

According to various embodiments, the system may determine the best possible medical venue or facility for the specific treatment required by the member. In some embodiments, determining the best medical treatment may include determining the venue, facility and doctor. Some of the criteria used to determine the best venue may include cost of treatment, quality of care, cost of travel, cost of lost productivity etc. In various embodiments, the health benefit system may evaluate various potential venues or facilities based on the various criteria. Based on the results of the evaluation, the system may recommend an overseas provider or suggest a facility in the home country. For example, in some embodiments, the system tallies up the costs associated with various possible venues, factoring costs of travel and accommodation. In some cases, a venue local to the patient may be the lowest cost venue once travel and accommodation are factored in, even if the actual medical costs are higher than at a remote venue. For example, a procedure may cost $4000 in India, and $8000 in the U.S. However, if travel to and accommodation within India costs $5000, then the US venue may be preferable, as the total cost of $8000 will be less than the total cost of treatment in India (i.e., $9000).

In some embodiments, the health benefit system 102 may evaluate a patient's suitability for travel. The system may offer treatment options based on the patient's suitability to travel. For example, the patient may be in a condition to travel for a few hours on a plane, but not for more than eight hours on a plane. Thus, for example, the system may present the patient with options for treatment in countries near to the patient's home country, but may not present options for treatment in more distant countries. For example, the system 102 may present a US-based patient with the option to receive treatment in Mexico, but may not present to such patient an option to receive treatment in India.

In some embodiments, health benefit system 102 may account for a patient's lost productivity in determining which treatment options to offer to the patient. For example, the system may determine, for two different possible options, how many days of work a patient will lose. If the patient will lose 20 days of work with a first option, and 10 days of work with a second option, then the health benefit system may offer the patient the second option but not the first option. In various embodiments, the health benefit system may only offer to a patient treatment options that will result in lost productivity that is below a certain threshold. For example, the system may offer to patients only treatment options that will result in lost productivity of 10 days or less.

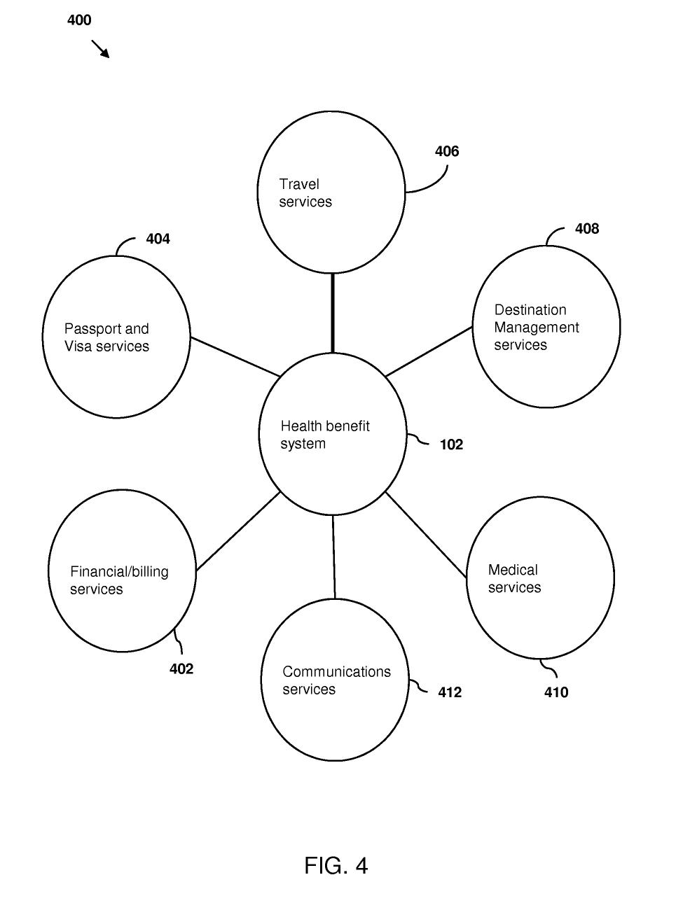

Service providers 108 may provide end-to-end health care services to members 106 of participating associations or organizations 104 in collaboration with health benefit system 102. According to some embodiments, service providers 108 may include, without limitation, medical service providers, travel service providers, and accommodation and logistics service providers. The services provided by service providers 108 as part of the health benefit plan are explained further in conjunction with FIG. 4.

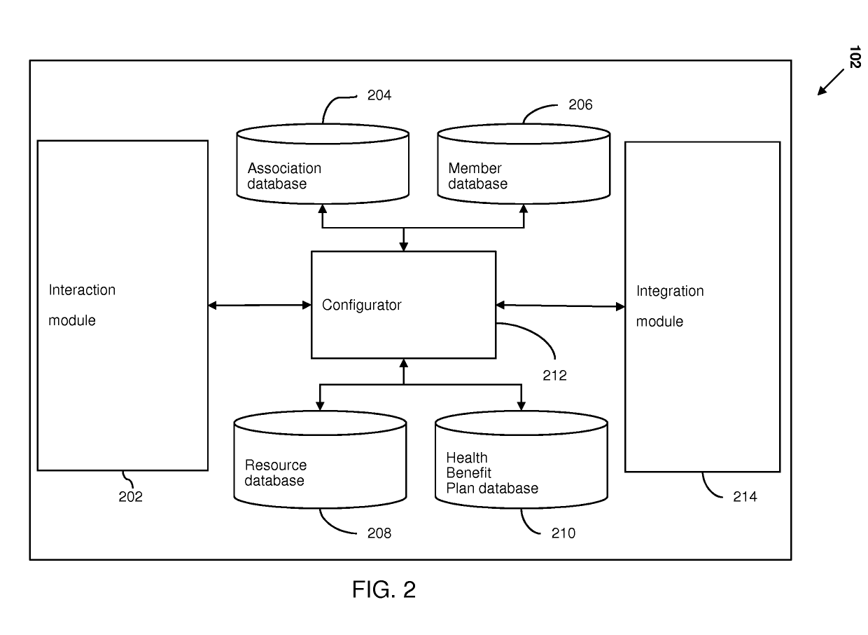

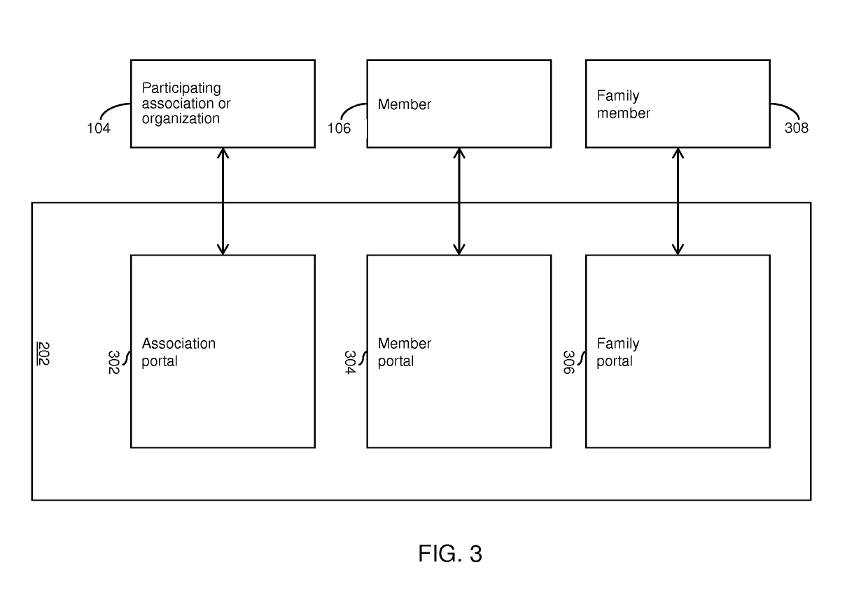

FIG. 2 shows a block diagram illustrating components of health benefit system 102. Health benefit system 102 may have an interaction module 202 which may act as an interface for members 106. According to some embodiments, interaction module 202 may be a web portal. Health benefit system 102 may be managed by a health plan administrator through interaction module 202. The web portal implementation of the interaction module 202 is described further in conjunction with FIG. 3. Through interaction module 202, members 106 may access information regarding the health benefit plan provided by health benefit system 102.

Association database 204 may store information about participating associations or organizations 104. The information may include data about members 106, the healthcare plan and policies specific to a participating association or organization 104, the utilization statistics, treatments undertaken by members, savings achieved by members and the association, average stay for treatments, number of enrollees, etc. The information about participating associations or organizations 104 may be stored and edited in association database 204. The information stored may also include the insurance plan of the association. For example, information stored may detail the insurance coverage available to each member of the association. Association database 204 is a secure database which, according to some embodiments, may be accessed by only participating associations or organizations 104.

Member database 206 may be a secure database which, according to some embodiments, may be accessed only by members 106 of participating associations or organizations 104. The member information may include, without limitation, name, age, gender, medical history, contact information, information regarding the medical condition of the member 106, details of previous treatments received through health benefit system 102, and the like. In various embodiments, the entire health record of member 106 may be stored electronically in member database 206. In some embodiments, access to this database may require a comprehensive authorization and authentication process. Members 106 may register and create a secure profile and may store and edit profile information in member database 206 through interaction module 202. The interaction module 202 may provide the information regarding the health benefit plan and the facilities available to members 106. According to some embodiments, member database 206 may contain testimonials and feedback by members 106 on the services provided by service providers 108. The interaction module 202 may also enable members 106 to perform a named or anonymous ranking and rating of the service providers.

The information about various service providers 108 may be stored in resource database 208. For medical services, resource database 208 may include information on healthcare providers, such information possibly including, locations, facilities, doctor biographies, treatment specialties, success ratios, procedural knowledge base, pricing data, testimonials, etc. The ratings and rankings of service providers 108 may also be stored in resource database 208. For travel services, resource database 208 may include information about travel providers, such information possibly including air fares, location details, facilities, tours, etc. Resource database 208 may also include data on other service providers such as merchants integrated into the system for car rentals, flower delivery at hospitals, etc.

Health benefit plan database 210 may contain information related to the health benefit plan. This information may include guidelines for pricing the medical care, details about the contribution to be collected from participating associations or organizations 104, the parameters or conditions for verifying the eligibility of members 106 for availing the services provided, the facilities available to members 106, and the like. The information stored may also include the insurance plan for each of the participating associations or organizations.

Members 106 and participating associations or organizations 104 may access the information from the various databases through interaction module 202. Association database 204, member database 206, resource database 208 and health benefit plan database 210 may be, according to some embodiments, collectively referred to as a knowledge base.

In various embodiments, configurator 212 acts as the processor of health benefit system 202. In various embodiments, configurator 212 may be considered as the intelligence engine of health benefit system 202. Configurator 212 may automatically update association database 204, member database 206, resource database 208 and health benefit plan database 210 upon any changes made to the information in these databases by participating associations or organizations 104, members 106, and service providers 108. For example, after receiving treatment, a member may give ratings to the health service provider. Configurator 212 may receive this rating through interaction module 202 and update the resource database accordingly. Configurator 212 aggregates the medical records of members 106 stored in member database 206 and processes the information to determine the services that are available to a particular member 106. When a member 106 logs into the system, configurator 212 may authenticate member 106 and may access the health benefit plan for member 106 from health benefit plan database 210. Configurator 212 may offer facilities/benefits, which are approved under the health benefit plan, to member 106. For example, when member, Helen, logs into the system, the system recognizes her as a member of Plan A which only covers treatment in India and offers 100% coverage for treatment including her travel as well as an accompanying attendant. Helen's resulting package offers may therefore include various options in India and list all the benefits available including those for the accompanying attendant. However, when member Roberto of Plan B logs in, the package for his treatment shows only the facilities in Costa Rica and Mexico. It does show the options for the accompanying attendant but flags all the costs as “Non-Covered” and “Self Pay”, for instance.

Configurator 212 may facilitate smooth and secure transfer of data between association database 204, member database 206, resource database 208, health benefit plan database 210, interaction module 202 and integration module 208. Configurator 212 may process the personalized work flows of each member 106. A member 106 requiring treatment may use interaction module 202 to interact with health benefit system and place a request for medical services. For example, member 106 may input the name of the illness for which she requires treatment. Additionally, the request may also include a name of the specific region where member 106 wishes to receive treatment. The request may also include any specific treatment that member 106 wishes to receive for the particular illnesses. For example, member 106 may indicate that she wishes to take only homeopathic treatment for the illness. As another example, member 106 may indicate that she wishes to undergo hip resurfacing rather than a hip replacement. Hip resurfacing, for example, may be an area where the expertise of overseas doctors exceeds that of doctors in the patient's home country. As another example, member 106 may indicate that she wishes to undergo allopathic treatment. In various embodiments, when a patient indicates a desire for a certain type of treatment (e.g., for hip resurfacing rather than for hip replacement), the health benefit system 102 may determine one or more available options through which the patient may receive the requested treatment. The system may select such facilities and/or doctors for providing a requested treatment based on the facilities' success rates with the treatment, based on the facilities' history of providing such treatments (e.g., based on the fact that the facility has provided more than a predetermined number of such treatments), or based on any other considerations.

In various embodiments, a request of member 106 may also include any other type of services which member 106 might want to use beyond the medical treatment. For example, member 106 may be interested in certain recuperation facilities. As another example, member 106 may be interested in utilizing tourism facilities in the country where she is going to receive treatment. Such requests may be typed in by member 106 in the space provided on interaction module 202. The request may be received by configurator 212, which may then prepare a comprehensive plan for the treatment of member 106. The request placed by member 106 and the information stored in various databases forms the basis on which configurator 212 prepares the plan. On receiving such a request, configurator 212 may retrieve information regarding the past medical records of member 106, and the facilities available to member 106. Based on the request and the information retrieved, configurator 212 may determine one or more suitable venues and/or facilities available which might be of interest to member 106. For example, member 106 may have requested for a bilateral hip replacement treatment. Additionally, member 106 might have indicated that she would like to receive treatment in an ‘Asian country’, and also that she would like to partake of tourism facilities in the country. In various embodiments, the health benefit system may first offer member 106 options for receiving treatment in various countries. A member may then choose from among the countries. The health benefit system may thereupon offer member 106 a choice of venues and/or facilities within the chosen country. In various embodiments, the health benefit system may indicate highlights or other features of particular countries or particular facilities. For example, health benefit system 102 may indicate that a facility has 10 board certified doctors. The system may indicate that one or more doctors at a facility has pioneered a particular treatment, has written articles on a particular treatment, has invented a treatment, etc. The patient may refer to the highlight in making his choice from among the options presented by the health benefit system. In various embodiments, once a patient has picked a country, facility and/or venue, then the health benefit system may ask the patient if he wishes to go to the venue earlier (e.g., three days earlier) to explore, sightsee, or otherwise visit.

In various embodiments, health benefit system 102 may store various data associated with one or more treatments. Such data may include recovery trajectories for a patient, restrictions that will be placed on a patient before or after treatment, conditions the patient will be in before or after treatment, and any other data associated with a treatment. The health benefit system may also store data about a patient, including biographical data (e.g., age, gender, etc.) and medical data. In some embodiments, the system may suggest activities for recuperation or recreation based on stored data related to a treatment and or to a patient. The suggestions may be designed to be most appropriate for a patient's anticipated status or condition at a particular time.

For example, if a patient is to undergo a hip replacement, then the system may know that the patient will have greater mobility before the procedure than after the procedure. Accordingly, the health benefit system 102 may suggest to the patient one or more recreational activities to be undertaken in the days before the procedure. For example, the system may suggest some activities that require walking around. As another example, if a patient is to undergo a dental procedure, the system may recognize that the patient will be restricted from traveling for several days after the dental procedure (e.g., because of potential adverse effects from a low-pressure airline cabin environment), but will otherwise be able to get around. Accordingly, for a patient set to undergo a dental procedure, the system may suggest activities for the patient that would occur after the dental procedure. In various embodiments, the system may suggest an activity or set of activities that fill a certain period of time, in which the period of time is determined to match the expected recovery time of the patient and/or to match the duration of any anticipated travel restrictions to be placed on the patient. Thus, for example, if it is expected that it will take the patient three days before he can travel again, then the system may suggest an activity or set of activities that will last for three days.

In various embodiments, a system may offer a facility as an option based on one or more criteria. Criteria may include accreditation/certification level, qualification of doctors/surgeons, success rates, experience and expertise, currency of equipment being used, and feedback. Feedback may include actual feedback from patients. In various embodiments, patients may rate a facility along one or more dimensions, and such feedback may be used in selecting facilities to offer to future patients. In some embodiments, patients may be able to view feedback left by prior patients of a given facility. Such feedback may be stored by health benefit system 102.

In various embodiments, patients of a facility may provide anonymous rankings or ratings. In some embodiments, feedback provided by patient may be grouped by patient nationality, by patient age, by patient gender, by patient's native language, or by any other patient characteristic. In this way, for example, a new patient may view the feedback from prior patients perceived to be similar to the new patient. For example, a patient from the US may wish to view feedback left by other US citizens, as the patient may wish to ascertain the difficulty of a US citizen receiving care while exposed to different cultures, customs, food, or other circumstances. In various embodiments, patients undergoing treatment overseas may be encouraged (e.g., by health benefit system 102, e.g., by an associate or employee of the system, such as a Destination Program Manager) to leave feedback at various stages of the process. For example, the patient may be encouraged to log on or otherwise connect to the health benefit system and provide his feedback. The patient may be encouraged to provide feedback after completing a leg of a journey (e.g., travel to the destination country), after receiving accommodation for a night, after meeting an attendant, after meeting a Destination Program Manager, after meeting doctors, after visiting a facility, after undergoing a procedure, after recovering, and/or after any other step or milestone in the process. In various embodiments, a patient may be given an incentive to provide feedback. The incentive may include perks, extra monetary allowances, or any other benefit.

In various embodiments, a facility or venue may be suggested, offered, selected, or ranked based on the difficulty of reaching the facility, such as based on the distance of the facility to an airport. Whether a facility that is difficult to reach is offered may also depend on the condition or suitability of the patient for travel. For example, if a patient cannot endure a 2-hour bumpy ride, then a facility that is two hour's drive from an airport may not be offered as an option for treatment.

In some embodiments, a facility or venue may be offered, selected, or suggested based on the climate at the facility. For example, during the summer in India, the temperature in Delhi may be uncomfortably hot, whereas the temperature may be more moderate in Bangalore. Accordingly, the system may suggest Bangalore over Delhi, or may rank Bangalore higher than Delhi.

Configurator 212, on receiving this request, may retrieve past medical records of member 106 and also the facilities for which member 106 is eligible. For example, configurator 212 may obtain records of previous bilateral hip replacement treatment received by member 106. The previous bilateral hip replacement treatment records may include the country where member 106 received treatment, name of doctors who were involved in the treatment, medical reports and doctor's opinions, and the feedback given by member 106. Additionally, configurator 212 may also retrieve results on bilateral hip replacement treatment obtained by other members. For example, another individual X may have received bilateral hip replacement treatment in country Y for which individual X gave good feedback. Such feedback may be retrieved by configurator 212. Further configurator 212 may also retrieve information which is relevant to other components of the request placed by member 106. For example, configurator 212 may retrieve information about which Asian countries offer facilities for a Bilateral Hip replacement treatment. Configurator 212 may consider surgeons' qualifications and experience, the type of medical equipment used, and the brand and quality of material such as prosthetics used for the treatment. As the request also includes availing of the tourism facility, configurator 212 may retrieve information on the various tourism packages currently available in Asian countries. Configurator 212 may also retrieve additional information which may be of relevance to member 106. For example, configurator 212 may retrieve any services offered in Asian countries, which although not requested by member 106, may still be of interest to member 106.

Using the procured information, configurator 212 may determine suitable medical treatment packages for member 106. Member 106 may be presented with various options for Bilateral Hip Replacement surgery. In the example above, configurator 212 may have retrieved information that ‘India’ and ‘Costa Rica’ are two countries which have facilities which provide Hip Replacement Surgery. The configurator 212, for example, may also have retrieved that another member earlier received Bilateral Hip Replacement surgery in ‘Thailand’ and that the feedback provided by another member was ‘good’. Configurator 212 may then retrieve the cost associated with receiving treatment at each of these three locations. Additionally, configurator 212 may retrieve the feedback given by other members for these three locations. Configurator 212 may also retrieve the various tourism packages available in India, Costa Rica, and Thailand, and also retrieve the cost associated with each tourism package. All the options may be presented to member 106, who may evaluate the options based on factors such as doctor's experience, testimonials about the service providers, the member's personal country of choice, etc. Member may also make decisions based on the rankings of the medical/tourism service providers. Member 106 may include/exclude the tourism package from the treatment services.

Based on the services selected by member 106, she may be presented with the total cost of the package. However, in various embodiments, a member may not be footing the bill for a particular package. Therefore, the member may not be shown the cost for the package. Various cost options may be provided to member 106. For example, Hip Replacement Surgery in the identified location in India may be costlier than that in Thailand. However, member 106 may be given some discount on a tourism package in India, so that overall Medical+Tourism cost for member 106 in India and Thailand is the same. Furthermore, post surgery recovery options that avail of alternate medical science such as homeopathy and ayurveda may be of importance to the patient and may help the patient to determine the venue of choice. For example, if the post surgery recovery requires homeopathy treatment which is available only in India, the member may want to go for treatment in India. Once the member narrows down his/her choices, the health plan administrator may be alerted and their authorization may be required for payment. The Plan Administrator may also engage with the member and offer his/her recommendations on the options being considered by the patient. A member may be billed before treatment is provided. Detailed invoices may be generated based on a pre-negotiated, pre-paid, fixed price package.

In various embodiments, health benefit system 102 has pre-negotiated, all-inclusive prices for a treatment, where such prices may include fees for the hospital, surgeon, anesthesiologist, and any other involved parties. For example a complete open heart surgery treatment package may be negotiated for $11,000. The health benefit system may take care of paying different providers, if such providers need to be paid separately. On the other hand, an insurance company or organization paying for the treatment may see only a single bill and may be responsible for paying only a single, aggregate charge. Therefore, according to various embodiments, organizations and insurance providers may enjoy simplified bill-paying and a greater degree of predictability in terms of how much a procedure will cost. In various embodiments, prior to the administration of treatment, estimated invoices may be generated by the health benefit system. The system may then collect the estimated amount from the payor. The system may then distribute this amount to facilities and/or to other providers. A second, final invoice may be distributed after treatment. In various embodiments, discrepancies may be paid and/or collected, as appropriate after the final invoice has been distributed.

In various embodiments, health benefit system 102 may take measures to prevent misuse of the system. Prior to approval of a treatment, the system may require written approval from a physician, such as from a trusted physician associated with the health benefit system. The health benefit system may require proof of any diagnostic tests or evaluations. The health benefit system may also require medical records indicating need. The health benefit system may track some or all monetary transfers, including money provided by associations/organizations and insurance companies, and money paid to providers. The health benefit system may also generate and provide (e.g., to associations and insurance companies) regular reports on the use of overseas medical facilities. Reports may include the number of times used, the total costs, success rates, and or any other data. Insurance companies may use these reports, for example, to look for any irregularities in costs or utilization, such as extra high utilizations of particular facilities over others. Reports may also indicate how much has been saved by the use of overseas facilities.

In various embodiments, integration with the payor's billing system may reduce costs, errors and time taken for approvals. For example, invoices may be transmitted electronically to the payor's billing system in a manner that is readily accessible to the billing system.

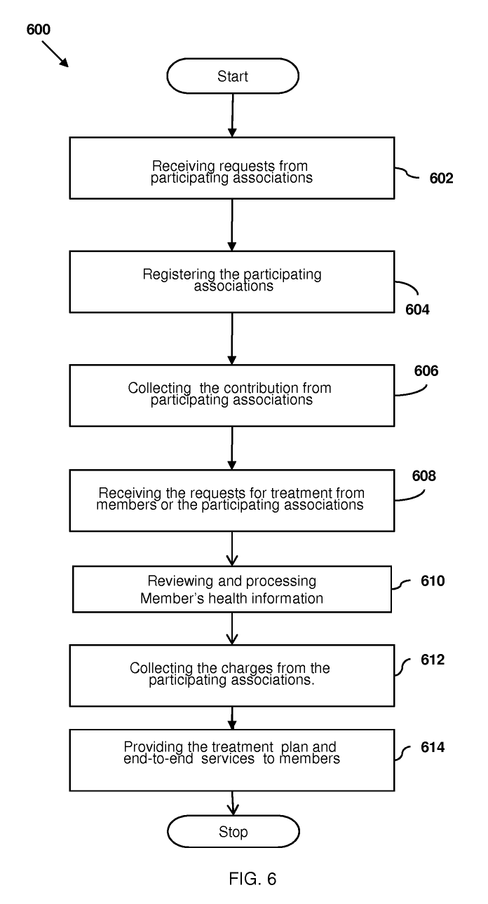

According to various embodiments, configurator 212 may calculate the contribution that each participating association or organization 104 has to pay to participate in the health benefit plan. The contribution may be calculated on the basis of ‘per member per month’. This is explained further in conjunction with FIG. 6. The information regarding the contribution and the other details of the health benefit plan may be communicated to participating associations or organizations 104 through interaction module 202. According to some embodiments, Configurator 212 may also perform the function of a travel booking engine. In some embodiments, Configurator 212 may pool information from various different sources, including a separate travel booking engine (e.g., from travel services block 406). Travel services block 406 may include travel-related information, destination information, packages, tourism, resort information, and so on.

Configurator 212 may facilitate the traveling of members 106 by providing them options for booking their travel tickets by collaborating with travel service providers 108. Configurator 212 may also rank service providers 108 based on rating parameters. These rating parameters may include, without limitation, pricing, testimonials and feedback given by members 106, geographic location, and facilities provided. These rankings may be stored in resource database 208.

Integration module 214 may integrate services provided by various service providers 108 to provide complete end-to-end services to members 106. Service providers 108 may be provided access to resource database and may store and edit their information in resource database 208 through integration module 214. Information regarding the health benefit plan and members 106 who are availing of the services may be communicated to service providers 108 through integration module 214. According to various embodiments, web portal may be used by service providers 108 to interact with the integration module 214.

FIG. 3 illustrates interaction module 202. According to some embodiments, interaction module 202 may be a web portal. The interaction module 202 may be used by participating associations or organizations 104, members 106 and family of members 106 to interact with health benefit system 102. According to some embodiments, interaction module 202 may include association portal 302, member portal 304, and family portal 306. Participating associations or organizations 104 may interact with health benefit system 102 through association portal 302, which may be a customized web portal. The association may also have additional functionality besides or in addition to functionality as a web portal. Participating associations or organizations 302 may access, store and edit the information regarding participating associations or organizations 302. Members 106 may interact with health benefit system 102 through member portal 304. Through member portal 304, member 106 may enquire and avail herself of the personalized facilities provided by health benefit system 102. According to some embodiments, member portal 304 may include a provision for selecting or booking venues for recuperation and/or for booking travel tickets and accommodation for members 106.

Family portal 306 may be a customized web portal for family members 308 of a member 106 undergoing treatment. Member 106 may designate some of his/her close relatives and friends as family members 308 who may access family portal 306. Family portal 306 may provide real-time access to a member's 106 health records and progress as permitted by Member 106. Family portal 306 may also enable members 106 and family members 308 to interact with each other. The different modes of interaction may include internet, mobile and land line telephones, PDAs, video conferencing and the like. Family portal 306 may also provide to family members 308 information related to the travel and accommodation of member 106 undergoing treatment. Family portal 306 provides a virtual support network for members 106, so that they can connect with family members 308 in their home countries. This gives moral support to members 106. Family portal 306 enables the patient to receive support from friends and family regardless of the location of the treatment. Friends and family authorized by the patient may be in constant touch. The latest news about the patient's condition may be available to the family members, who may send messages, flowers, and cards to the patient. Authorized individuals may have virtual face-to-face interaction with the patient through the use of video streaming and may also interact with the patient's doctor/medical team to remain involved in the patient's health and treatment.

In various embodiments, the Health Benefit system may track the location of a member and update the family portal in real, or near real time. For example, the family portal may show a map with a dot pinpointing the location of the member at any given moment. The location of the member may be tracked using reports from service providers (e.g., a logistics provider may report that the member has been transported to a given location on schedule; e.g., a hotel desk attendant may report that a member has just arrived), by the member himself (e.g., the member may phone in his location), automatically (e.g., the member may carry an electronic device that automatically reports its location), by an attendant traveling with the member, or by any other means.

In some embodiments, a family member may be provided with a convenient user interface for getting in touch with the member. For example, a single click of a button labeled “contact member” may trigger the health benefit system to open up a line of communication between the family member and the member. The health benefit system may select the most appropriate form of communication based on the location and/or status of the member. For example, if the member is by a hospital phone, then the health benefit system may initiate a phone call to the phone. If the member is near a video-conferencing facility, then the health benefit system may initiate a video conference with the member. If the member has a cell phone or a personal digital assistant, then the health benefit system may initiate a phone call or send a text message to the member's device.

According to some embodiments, interaction portal 202 may have a provision for community interaction. User forums and blogs may be provided for the discussions between people. Further, news and information about the medical service industry and service providers 108, especially about hospitals and doctors, may be provided.

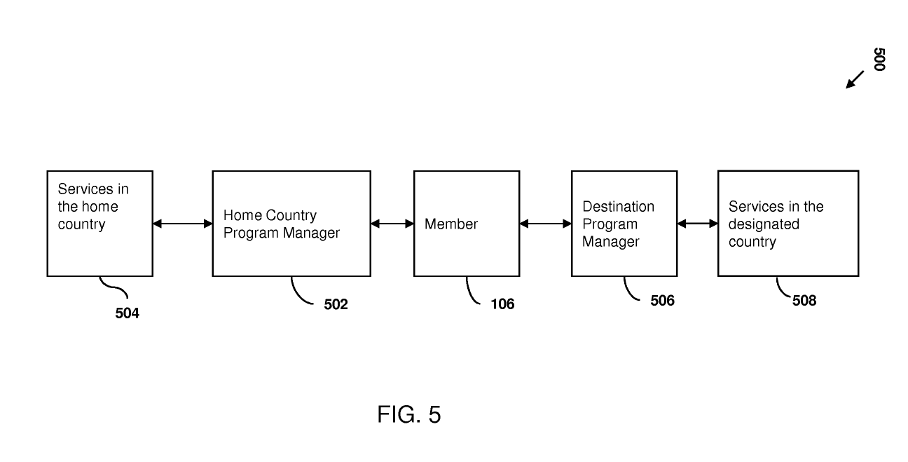

FIG. 4 illustrates various services that may be offered by the health benefit plan to members 106 through service providers 108, according to some embodiments. Financial and billing services 402 may include taking care of financial needs of member 106 in the countries where the treatment is provided. Financial needs may include the finances required for treatments as well as for other services, such as tourism, utilized during that period. Financial and billing services 402 may provide for insurance for member 106 to cover the expenses. For example, financial and billing services 402 may send a bill to the member's health insurance provider to cover the member's expenses. Finance and Billing Services 402 may also integrate with each association's financial system and may update the insurance payor's system and the association's system. This may give the health plan Administrator full control and visibility into the healthcare costs of each member as well as that of the association as a whole. All this may be done through a secure access system. Passport and Visa services 404 may be provided to members 106 to assist them in arranging for passport and visa to travel to the destination country where treatment is to be done. Travel services 406 may be provided to members 106 to arrange for travel to the destination country. Travel services 406 may include services related to the booking of tickets and the arrangement of travel within the destination country. Destination management services 408 may be provided to members 106 to facilitate the stay of members in the destination country. This is explained further in conjunction with FIG. 5. Medical services 410 may be provided in hospitals with suitable medical facilities and physicians. Medical services 410 may include diagnostics, pretreatment, treatment and post treatment health care. In various embodiments, annual health check-ups may be done overseas. These may be included in plans offered by health benefit system, for example. The cost of performing a whole range of diagnostics may be lower overseas just one or two diagnostics if performed in a member's home country (e.g., within the US). Communication services 412 may be provided to members 106 to manage communication between health benefit system 102 and members 106 and also between members 106 and family members 308. The information may include secure transfer of medical records, consultations with doctors and other service providers, and ongoing communications with family members throughout the medical travel process. Several means of communication may include voice, video and data transfer through internet, land and mobile phones, PDAs and the like.

FIG. 5 illustrates relationships between members 106 of participating associations or organizations 104, managers appointed by health benefit system 102, and various end-to-end services that are provided by health benefit system 102 in accordance with various embodiments. A Member 106 may be assigned a Home Country Program Manager (HCPM) 502. HCPM 502 may facilitate the entire medical travel process starting from the initial identification, selection and subsequent scheduling of the procedures with the selected surgeons in the selected facilities. HCPM 502 may serve as a personal assistant to members 106 at their home country. Any communication regarding health care services with members 106 may be done by HCPM 502. Services, other than medical services, in the home country 504 may also be facilitated by HCPM 502. For example, HCPM 502 may assist members 106 in obtaining visa and passport and completing the formalities relating to the journey to the destination country. HCPM 502 may also provide pre-travel information to members 106. The pre-travel information may include content about the treatment provided, profiles of the doctors and surgeons, facilities data, details on the destination country, determined itinerary of member 106, and the like. HCPM 502 may also take care of preliminary treatment given to members 106 in their home country before the actual treatment starts in a foreign country.

After a member 106 has chosen a destination country, he/she may be offered the services of Destination Program Manager (DPM) 506 to provide destination management services 406. DPM 506 may receive member 106 upon his arrival in the destination country and may serve as a personal assistant to member 106. DPM 506 may assist Member 106 through the entire treatment process, providing assistance in working with the medical facilities and ensuring that the treatment is done as per schedule and expectation. DPM 506 may assist member 106 with additional needs for accommodation in hotels, hospitals and resorts as desired by member 106. DPM 506 may assist member 106 in travel in the destination country. For example, DPM 506 may provide information about the tourist places in the destination country to member 106. For example, DPM 506 may provide information about post-surgery recovery centers, and attractions in the destination country, including tourist attractions, medical attractions, and any other attractions in the destination country or elsewhere.

FIG. 6 is a flowchart illustrating the process involved in implementing health benefit plan in accordance with various embodiments. At step 602, health benefit system 102 may receive a request from an association to associate with and utilize the benefits of the health benefit plan. At step 604, health benefit system 102 may register the requesting association with the health benefit plan. Thereafter, the registered association is a part of participating associations or organizations 102 and its members may avail themselves of facilities offered by the health benefit plan of the health benefit system 102.

Health benefit plan may cover a comprehensive set of end-to-end services that enable participating associations or organizations 102 to take advantage of healthcare facilities in developing countries and achieve significant savings. At step 606, participating associations or organizations 102 may make the payment on ‘per member per month’ basis. The amount paid by participating associations or organizations 104 may serves as a contribution towards the health benefit plan. The amount per member may be determined based on the information obtained from association database 204. ‘Per member per month’ based contributions may be sponsored by insurance companies. According to some embodiments, participating associations or organizations 104 may be self insured associations. Some share in the savings achieved by participating associations or organizations 104 may also be collected as contribution towards the health benefit plan by health benefit system 102.

Note that, in various embodiments, the contributions are not insurance premiums, nor do they give members access to fully covered medical care. Rather, contributions provide members with access to discounted health care packages. Members and organizations can still be covered separately under medical insurance plans. These medical insurance plans can then cover the actual costs of receiving the discounted medical services. However, members and associations may still benefit from lower insurance premiums as medical insurance companies may pass on the savings obtained from the discounted health care packages. In some embodiments, the medical packages may confer such savings that medical insurance companies would be willing to pay not only for medical services, but also for accompanying tourist activities.

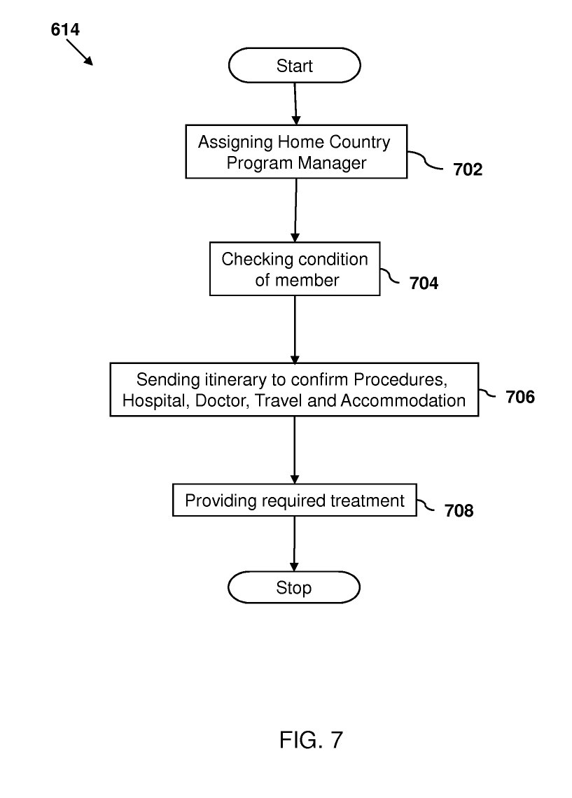

At step 608, members 106 from participating associations or organizations 104 who require medical treatment may request health benefit system 102 to provide the required treatment plan. At step 610, the medical information of members 106 is reviewed and processed. The medical information may include, without limitation, a medical history, the medical condition of the patient, results of the diagnostics, the severity of the health problem and ability of member 106 to travel. Member 106 may be asked to fill a questionnaire about his/her medical history. The medical history of member 106 may be required for providing suitable and safe treatment to the member. The medical information may be sent to the doctors abroad and their recommendation may be sought regarding the suitable treatment and pre-treatment procedures. The doctors may also provide suggestions on care to be taken while member 106 is in his/her home country. At step 612, the treatment charges may be collected from the sponsors. The sponsor may be participating associations or organizations 104 or the insurance company with which participating association or organization 104 has established contract. The price quotations may be provided to members 106 and/or the sponsors of the medical treatment of members 106. According to some embodiments, the price quotation may include the packaged cost of all surgical or treatment procedures, including the cost of all medical doctors, facilities, diagnostics, and medications. According to some embodiments, the price quotation may additionally include the cost of traveling and accommodation. The price quotations may be reviewed as per the Plan provisions and the “self-pay” portion of the overall package. If member 106 accepts the price quotation, then an itinerary that is best suited to member 106 is developed. Billing may be done at one instant. A complete invoice of all itemized costs to health benefit plan may be provided to the sponsor. At every step, member 106 may be informed about the aspects of the medical treatment and travel that are covered under the Plan. Any additional Non-Covered items may be flagged for the Plan participant (Member 106) and special agreement with member 106 may be required to ensure payment of these non-covered services. A detailed invoice may be generated for the Insurer/Plan Administrator with a separate or additional area for the inclusion of specific personal or non-covered services to be paid for by the Plan Participant/member 106. At step 614, the treatment plan and comprehensive end-to-end services are provided to member 106. This step involves the checking of the medical history and the present medical condition of member 106. Once qualified for overseas treatment, members 106 may be provided with the treatment plan including the required procedures in destination countries where the cost of treatment is less than in the member's home country. Comprehensive end-to-end services may be provided to member 106. The comprehensive end-to-end services may include passport or visa acquisition, providing pre-travel information, providing transportation to the destination country and accommodation in the destination country, providing for the transport in the destination country, and facilitating the treatment and nursing care to members 106. Step 614 is further explained in conjunction with FIG. 7.

An insurance plan covering major medical in-patient treatment for non-emergency procedures in countries like India is provided according to some embodiments. This insurance plan may be provided for associations and organizations as well as uninsured individuals and individuals who do not have adequate insurance. The insurance plan may be provided at substantially lower premiums than are currently available in markets such as the U.S. This plan may cover all diagnostics, treatment and post-surgical care, as well as the travel costs associated with traveling to the country of the healthcare facilities. This plan may be combined with a mini-medical plan which provides basic coverage for doctor visits, certain diagnostics, and outpatient treatment, but with a maximum cap on the costs for such visits and treatment. This plan may have a maximum annual and lifetime cap and may be offered at a significant cost savings.

FIG. 7 is a flowchart illustrating the comprehensive end-to-end services provided to members 106 in accordance with various embodiments. At step 702 members 106 may be introduced to HCPM 502 who takes care of all the procedures performed in the home country of member 106. HCPM 502 may communicate with members 106 over phone, fax and instant message or via Email. At step 704, the members 106 may be asked to undergo medical checkup. The checking may includes performing diagnostics such as X-rays, MRI scanning, ECG, testing of blood and other bodily fluids. Data gathered on the member's medical condition may be forwarded to and stored with the health benefit system 202. The severity of the health problem may also be assessed during diagnostics. Based on the assessment, the dates of the treatment may be determined for members 106. The itinerary of members 106 may be designed based on this assessment. In various embodiments, a medical team, which may include local physicians and the overseas providers (e.g., surgeons), may review the case. In various embodiments, a patient may ask to speak to multiple providers (e.g., to three different surgeons). The patient may wish for multiple opinions, for example. The system may recommend times that the patient can speak with a given surgeon or other provider based on time differences between the two. A patient may pick from among available times (e.g., from among times when both would be expected to be awake). The patient may pick a time, and schedules an initial consultation to review the case. The patient may have the option to include his/her own doctors within the patient's own local country as well. Thus, according to various embodiments, health benefit system 102 may facilitate the interaction between trained medical professional and the patient.

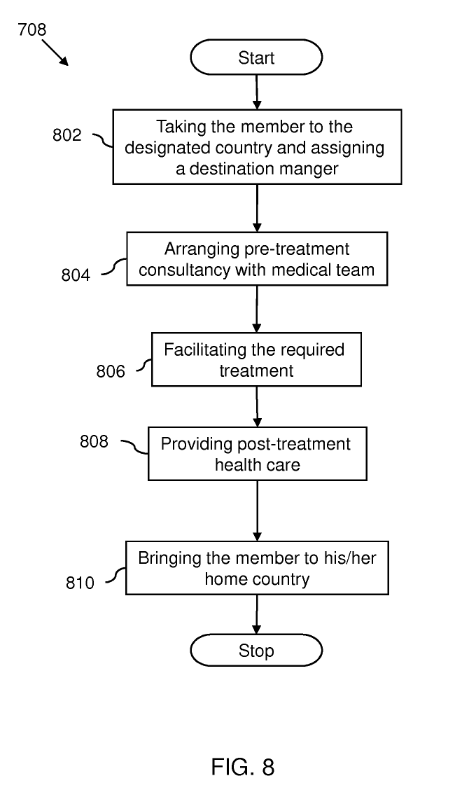

At step 706, all the reservations may be made and the entire itinerary may be sent to member 106 for his/her review and confirmation. The travel information may also be provided to the members along with the itinerary. At step 708, member 106 may be assisted in receiving treatment. Step 708 will be further explained in conjunction with FIG. 8.

FIG. 8 is a flowchart describing the procedure of providing treatment to members 106 in accordance with various embodiments. At step 802, member 106 may be taken to the destination country for treatment. The formalities like acquisition of visa and passport may be completed by member 106 with the help of HCPM 502. The member may also receive help from the health benefit system. For example, the HCPM and/or the health benefit system may transmit to the member the proper forms to be filled out, information about the proper places to visit, information about the proper documents to bring (e.g., two forms of identification) and may otherwise facilitate the acquisition of visas, passports, and other travel-related documents. Reservations may be made (e.g., by the health benefit system and/or by the HCPM) for the member's travel, accommodation, and hospitals. The travel to tourist places after the treatment may also be provided so that the member may enjoy a vacation in conjunction with receiving treatment. DPM 506 may be allotted to one or more members (e.g., to every member) getting treatment in the destination country. DPM 506 may serve as a personal assistant to members 106 throughout their stay in the destination country. DPM 506 may accompany a member for doctor's appointments and medical treatments. In various embodiments, a DPM may be assigned to a member by the health benefit system. For example, the health benefit system may transmit a message (e.g., an email) to a DPM, informing the DPM that the member will be arriving in the destination country on a particular date and time, on a particular airline, and that the DPM should greet the member accordingly. The health benefit system may further communicate to the DPM an itinerary for the member. The itinerary may include information about scheduled accommodations for the member, scheduled medical treatments, dates and times for the medical treatments, and any other pertinent information. In some embodiments, the DPM may be provided with only a few specific requirements (e.g., the member must be at a given hospital at a given date and time), and may otherwise be left with flexibility to plan and arrange the member's stay in the destination country as the DPM sees fit. The DPM may be encouraged or required to periodically update the health benefit system on the status of the member. For example, the DPM may be required to transmit to the health benefit system the location of the member at three specific times per day (e.g., at 8:00 am, 2:00 pm, and 8:00 pm).

Support may be provided to members 106 during their stay in the designated countries through family portal 306. At step 804, a pre-treatment consultation may be arranged with a medical team. For example, the health benefit system and/or the DPM may schedule a time, date, and location for the pre-treatment consultation. During the consultation, the medical team may go through member's 106 medical records and perform required additional tests. These procedures may ensure that member 106 is readied for further treatment or surgery. Results of the pre-treatment consultation (e.g., test results, physician evaluations of the patient, etc.) may be communicated to the health benefit system by the physicians, DPM, by the member, or by some other party. The results may be stored and/or may be made available for perusal by the member's family, primary physician, or be any other authorized parties.

At step 806 the required treatment is facilitated to member 106. The treatment is provided in the predetermined hospitals by an assigned medical team. The occurrence of the treatment and any immediate results of the treatment (e.g., “no complications”, e.g., “surgery took 4 hours”, “e.g., patient is resting well”, “e.g., patient is awake”) may be reported to the health benefit system. For example, the physicians providing the treatment, other hospital staff, and/or the DPM may report on the occurrence and results of the treatment.

After member 106 has received the required treatment, post-treatment procedures may be provided to member 106 at step 808. The provision and the results of post-treatment procedures may likewise be reported to the health benefit system. Once the assigned medical team is satisfied with member's 106 health condition, member 106 may be allowed to engage in various activities in the process of recuperation. In various embodiments, the patient may be allowed to visit various attractions the destination country offers. DPM 506 may assist members 106 during his recuperation and/or travel. For example, for recuperation, a patient may visit a beach and relax. The patient may have a final visit with doctors before departing the country (e.g., after four days of recuperation). According to various embodiments, the system may assist the patient with recuperative activities that allow the patient to stay within the vicinity of his doctors for any post-treatment consultations that may be required. In step 810, when all the required procedures have been finished, the member 106 may be brought to his/her home country.

In various embodiments, post surgery follow-up is possible through the system. The attending surgeon may be engaged by member 106 and/or his local medical team to discuss any further and ongoing treatment. All medical records may be input in the system in a single, consolidated repository allowing the member 106 and his/her authorized representative(s) access to the medical records at any time.

In various embodiments a member is provided with control over his/her healthcare decisions. The member is offered options based on the type of treatment sought, provider expertise, the member's travel preferences, and the scope of the healthcare plan in which the member is enrolled. Different treatment and travel options are assembled with a view to reducing or minimizing package prices. For example, if five different providers are required to form a package (e.g., providers of logistics, accommodations, medical care, etc.), then prices for various combinations of five providers will be considered before settling on the combination of five providers that offers the lowest price. In some embodiments, features of a package are flagged as an ‘authorized benefit’ or ‘personal pay’. The member has the choice to opt for an entirely authorized treatment or to agree to pay for additional items that are not authorized, but which may be of particular interest to the member. Unauthorized items could include a special treatment, a specific facility, specific medical provider, and personalized travel and tourism requirements.

In various embodiments, a member is evaluated in various ways before certain treatment options are offered to the member. In various embodiments, a member's local doctors (e.g., primary care physicians) identify the need for treatment, after which local and overseas providers jointly evaluate the member's medical records to determine a treatment plan. The health benefit system may facilitate interaction among the local and overseas medical providers, and the member's medical records may be made accessible to the joint team authorized by the member.

In various embodiments, steps may be taken to qualify a member for medical travel. In some embodiments, a registered nurse and/or a case manager may work with the member to assist in the qualification of the member for a healthcare benefit. The registered nurse and/or case manger may determine whether the member's condition qualifies for surgical treatment, whether an appropriate procedure is offered overseas at a facility aligned with the health benefit system, and whether the treatment meets a pre-defined minimum threshold level to justify travel and other costs associated with the benefit.

Following the aforementioned determinations, the member may be further qualified. In various embodiments, one or more surgeons (e.g., surgeons which may treat the member) may, with reference to the member's medical records, and in conjunction with the member's medical team (if available), determine the member's condition for travel and for responding positively to the treatment plan. Depending on the procedure being contemplated for the member, there are a number of criteria that may be evaluated so as to qualify the member or determine the appropriateness of the procedure. For gastric procedures, for example, the BMI index, and the number of years the member has suffered from obesity and co-morbidities are essential indicators. For cardiac procedures, for example, the member's blood pressure and the severity of the heart condition are important criteria. For orthopedic patients, the severity of the condition and the current mobility of the member are criteria that are used to determine qualification levels. In various embodiments, a medical release form stating that the member is able to travel overseas for treatment is required.

In various embodiments, a health package is assembled based on a sequence of priorities. In some embodiments, the highest priority is to satisfy medical requirements (e.g., to provide treatments which will result in the best health outcomes). Various criteria used for assembling a package may include assembling a package that provides the treatment required, obtaining providers which meet certain quality standards (e.g., quality standards based on doctor experience, expertise, equipment used, and accreditation), assembling a package that is low in price (e.g., a package that includes a low-priced procedure), and assembling a package that factors in the patient's condition to undertake the medical travel. Other criteria may include a patient's preference for a particular location, and other tourism interests.

In various embodiments, providers are evaluated before they are used in the provision of health care packages and medical travel. In various embodiments, providers are evaluated according to certain criteria. In some embodiments, a provider's facilities and a doctor's qualifications are evaluated. Facilities may be visited in person by experts and/or by others, and evaluated. The experts may be associated with the health benefit system. Provider facilities (e.g., hospitals) may be graded on their quality of care, the qualifications of their surgeons and doctors, the modernization of their equipment, their staff's communication skills, and infection control, among other criteria. A facility may also be evaluated based on its procedural availability, its pricing, and the overall patient experience. A facility may also be evaluated based on its JCI accreditation and based on whether it has U.S. board certified doctors on staff.

In various embodiments, in order to be utilized (e.g., offered as an option to members), a medical facility must meet or exceed United States standards for cleanliness, safety, professionalism, and competency. In various embodiments, a hospital must be internationally accredited by Joint Commission International (JCI) or certified by the ISO. In various embodiments, a hospital must be certified by the International Organization for Standardization. In various embodiments, in order to be utilized, a medical facility must offer outstanding surgical services staffed fully with English-speaking professionals and must present immediate accessibility.

In various embodiments, in order to be offered as an option to patients, a medical facility must utilize current and standard medical equipment available (e.g., equipment purchased within the last 5 years). Facilities may be periodically evaluated as to their modernization with the help of international health professionals. In various embodiments, facilities may be evaluated to ensure that they employ well-trained and competent staff members.

In some embodiments, a facility is evaluated with routine on-site inspections (e.g., following an initial visit) that may ensure that the facility maintains the highest standards of care and continually earns its stated accreditations. Inspection criteria may include: standards of sanitation, infection control and hygiene protocols; the disposal of waste and sharps; food preparation and quality; and security and safety for staff and patients.

In various embodiments, providers who have met various criteria (e.g., criteria for competence, cleanliness, board certification etc.) may be added the resource database 208. Various information about the providers may also be added. In some embodiments, providers may be given access to the resource database and may have the opportunity to add and/or update information about themselves.

In various embodiments, a provider facility may be inspected on a periodic visit. One or more experts or staff associated with the health benefit system may visit the provider facility. Visits may occur, for example, every three months, every six months, on a random basis, on a surprise basis, or according to any other schedule. Inspectors of a facility may view and obtain data pertaining to blood safety, hygiene, and equipment age, among other things.

In various embodiments, providers may be utilized (e.g., in conjunction with health benefit plans offered according to various embodiments), based on success rates achieved by the providers. Success rates may measure the percentage of times that a particular procedure or treatment has improved the health or condition of a recipient of the procedure, has cured the recipient, has prevented further deterioration of the health of the recipient, has alleviated pain of the recipient, or has otherwise benefited the recipient of the procedure. In various embodiments, a provider may be evaluated against one or more comparable or analogous providers in a particular country, such as in the U.S. For example, hospitals specializing in cancer treatment in India, Thailand, and Costa Rica may be evaluated against hospitals specializing in cancer treatment in the U.S. (e.g., against a particular U.S. hospital specializing in cancer treatment; e.g., against an “average” of 10 U.S. hospitals specializing in cancer treatment). Hospitals outside the U.S. may be used as providers, according to various embodiments, only if the success rates at such hospitals are comparable to, or exceed success rates at corresponding U.S. hospitals.

Various embodiments include a virtual support network (VSN). The virtual support network may enable a member to receive support from friends and family regardless of the location of the treatment. Friends and family authorized by the member may be in frequent or constant contact with the member. In some embodiments, the latest news about the member's condition is made available to the members of the VSN and the ability to send messages, flowers, cards is easily available (e.g., to friends and family; e.g., to members). In various embodiments, authorized friends, family, and others may have virtual face-to-face interaction with the member through the use of video streaming, and may further interact with the member's doctor/medical team to remain involved in the member's health and treatment.

### Various Embodiments

As described herein, a recreational activity may include a leisure activity and/or an activity facilitating recuperation from a medical treatment. A recuperation activity may include a stay at a beach resort, a visit to a spa, a stay in the mountains, or any other activity which may in some way aid in recovery, recuperation, relaxation, and/or preparation to resume normal activities. In various embodiments, a leisure activity may include sightseeing, visits to parks, visits to landmarks, shopping, dining, attendance of performances or fairs, learning activities, or any other activities.

1. A system comprising a server, the server operable to:
store information about members of a health plan;
store information about organizations of members;
store information about health benefit plans;
store information about service providers, including service providers in at least two different countries;
store information about which health benefit plans correspond to which members;
store information about which health benefit plans correspond to which organizations;
periodically bill the organizations based on the organizations' corresponding number of members and corresponding health benefit plans;
receive an indication that medical treatment is required by a first of the members;
determine an appropriate treatment option for the first member based on a health benefit plan that corresponds to the first member, based on the medical treatment required, and based on the information about the service providers, in which the first member resides in a first country and the treatment option includes treatment in a second country that is not the first country;
suggest recreational activities for the first member to engage in while the first member is in the second country;
determine a price for the treatment option;
determine a price for the recreational activities;
obtain commitments from a subset of the service providers to provide treatment, logistics, and other services in connection with the treatment option;
monitor the progress of the first member as the first member travels to and within the second country, and as the first member receives treatment;
communicate with the first member;
communicate with friends and family of the first member;
transmit periodic updates on the status of the first member to the friends and family of the first member;
place the first member in direct communication with the friends and family of the first member;
receive feedback from the first member related to the first member's treatment;
store the feedback of the first member;
determine ratings for the subset of service providers based on the first member's feedback;
bill an insurance provider associated with the first member for the first member's treatment;
receive payment from the insurance provider; and
pay the subset of service providers.

2. A method comprising:
determining first identifying information about a patient;
receiving from the patient an indication of second identifying information about an associate of the patient;
providing to the associate a first access key for use in obtaining status information about the patient;
determining a sequence of destinations to which the patient will go;
determining, for each of the sequence of destinations, a procedure that the patient will undergo at the given destination;
determining, for each of the sequence of destinations, a time when the patient will reach the destination;
receiving an indication that the patient has reached a first of the sequence of destinations;
receiving an indication that the patient has undergone a first procedure at the first of the sequence of destinations;
receiving first status information about the patient;
receiving a request from the associate to check on the status of the patient, the request including the first identifying information;
receiving from the associate a second access key;
verifying that the second access key matches the first access key;
providing to the associate, based upon successful verification, first status information about the patient.

3. The method of claim 2 in which status information is one of: information about the patient's health; patient medical records; patient vital signs; information about the patient's location, information about the success of the first procedure; information about the patient's prospects for recovery; information about the patient's anticipated arrival time at one of the sequence of locations; information about the patient's anticipated length of stay at one of the sequence of locations; information about a doctor treating the patient; information about a person attending to the patient; contact information for the patient; a video of the patient; an audio clip of the patient; a picture of the patient; a map showing the location of the patient; a map showing the sequence of locations; a message from the patient; and information about activities in which the patient is engaging.

4. The method of claim 2, further comprising:
receiving a request from the associate to communicate with the patient;
determining a current location of the patient;
determining a communication device available to the patient at the patient's current location;
relaying the associate's request to the patient;
receiving an indication that the patient is amenable to communicate with the associate;
receiving a first signal from the associate;
transmitting the first signal to the patient via the communication device; and
receiving, via the communication device, a second signal from the patient.

5. The method of claim 4 in which the signal is one of: a video signal; an audio signal; an electronic text message; and an electronic chat message.

6. The method of claim 2, further comprising:
receiving a request from the associate to send an item to the patient;
determining a provider of the item in the vicinity of the first destination; and
arranging for the provider to deliver the item to the patient.

7. The method of claim 2 further comprising:
receiving a contact address from the associate; and
receiving from the associate an indication of a schedule according to which the associate will be provided with status information about the patient, in which providing first status information includes transmitting to the contact address first status information in accordance with the schedule.

8. The method of claim 7 in which the contact address is one of: an email address; a phone number; an instant messaging address; an instant messaging handle; an address for receiving text messages; and a postal address.

9. A method comprising:
receiving an indication that a member residing in a first country may require medical treatment;
determining a medical history of the member;
determining one or more symptoms experienced by the member;
receiving from a first physician a first evaluation of the member's current medical condition;
determining whether the member is in a suitable state of health for travel, the determination of suitability made based on one or more of: the medical history, the one or more symptoms, and the first evaluation;
receiving a recommendation of a treatment for the member;
determining a first option for administering the treatment, in which the first option includes administration of the treatment in a second country, and in which the second country is not the same as the first country;
determining a second option for administering the treatment, in which the second option includes administration of the treatment in a third country, and in which the third country is not the same as the first country;
providing to the member first details about the first option;
providing to the member second details about the second option;
receiving a selection from the member of the first option over the second option;
determining an urgency with which the treatment must be administered;
receiving from the member an indication of a desired time period within which to receive treatment;
determining a length of time required for the member to receive authorization to visit the first country, in which the length of time required to receive authorization is determined based on one of: a length of time required for the member to obtain a visa, and a length of time required for the member to obtain a passport;
arranging for travel reservations for the member to travel to the second country, in which the travel reservations are for a date chosen based on at least one of: the urgency, the received indication of the desired time period, and the determined length of time required for the member to receive authorization to visit the first country;
receiving a first indication that the member has arrived in the second country;
receiving a second indication that the member has completed treatment;
receiving a third indication that the member has departed the second country;
receiving from the member an authorization for a third party to receive updates about the member;
transmitting the first, second, and third indications to the third party;
receiving from the member feedback on his completed treatment; and
storing the feedback.

10. The method of claim 9 further comprising:
determining a first price associated with the first option;
determining a second price associated with the second option, in which the second price is lower than the first price;
determining a difference in price between the first price and the second price;
informing the member that selection of the first option will require the member to pay the difference in price with his own money;
billing the member for the difference in price upon the member's selection of the first option over the second option; and
receiving a payment from the first member equal to the difference in price.

11. The method of claim 9 in which determining the first option includes:
retrieving feedback information about services to be provided in accordance with the first option; and
determining that the feedback information meets predetermined criteria.

12. The method of claim 9 in which the recommendation of the treatment includes a recommendation of first treatment to be undergone in the member's home country, and a recommendation of second treatment to be undergone in a country other than the member's home country.

13. The method of claim 9 in which providing first details includes providing to the member at least one of: the name of the second country; pictures of the second country; the name of a facility at which treatment would be administered under the first option; pictures of the facility; the name of a doctor that would administer treatment under the first option; a profile of the doctor; testimonials about the facility; testimonials about the doctor; attractions in the second country; the price of the first option; and the price of engaging in tourist activities within the second country.

14. The method of claim 9 further comprising:
determining a recreational activity within the second country;
determining a cost for the member to engage in the recreational activity;
determining a price for the member to engage in the recreational activity, the price determined based on the cost;
offering the member the opportunity to engage in the recreational activity as part of his visit to the second country;
presenting the member with the price;
receiving from the member an indication of a desire to participate in the recreational activity;
determining a set of service providers who can facilitate the member's participation in the recreational activity;
determining a schedule according to which each of the service providers will provide services to the member;
receiving commitments from each of the service providers to provide services to the member according to the schedule;
verifying that each of the service providers has provided the services to the member; and
providing payment to each of the service providers.

15. The method of claim 9, further comprising determining a first service plan to which the member subscribes, in which determining the first option includes determining whether the first option is available to subscribers to the first service plan, and in which first details of the first option are provided to the member only upon a determination that the first option is available to subscribers of the first service plan.

16. The method of claim 9, further comprising:
determining an insurance provider of the member;
transmitting to the insurance provider an indication of the medical history, the one or more symptoms, and the first evaluation;
transmitting to the insurance provider first details about the first option; and
receiving from the insurance provider authorization to proceed with the first option.

17. The method of claim 16 further comprising:
receiving from the insurance provider payment for the provision of services associated with the first option.

18. The method of claim 9 in which determining the first option includes:
determining a service plan to which the member is a subscriber;
determining a price limitation that applies to the service plan;
determining a rating limitation that applies to the service plan;
determining a first set of potential service providers that might provide services to the member in accordance with the first option;
determining a price associated with each service provider;
determining a rating associated with each service provider; and
selecting a second set of service providers from among the first set of potential service providers, the second set of service providers selected based on the prices and ratings associated with each service provider in the first set of potential service providers, in which the second set of service providers are selected so as to comply with the price limitation and the rating limitation.

19. The method of claim 9 further comprising:
providing to the member instructions for actions that should be taken prior to departure to the second country.

20. The method of claim 19 in which providing instructions includes:
providing to the member instructions on medical care that should be obtained prior to departure for the second country; and
providing to the member instructions on documents that should be obtained prior to departure for the second country.

21. The method of claim 9 in which determining the first option includes:
determining a facility in the second country; and
determining a distance of the facility an airport, in which determining the first option includes determining the first option based on the suitability and based on the distance of the facility to the nearest airport.

22. The method of claim 9 further comprising:
determining a savings associated with the first option; and
providing a portion of the savings to the member.

23. The method of claim 9 further comprising:
determining a length of a travel restriction that will be placed upon the member following administration of the treatment, in which the determination of the length of the travel restriction is made based on the nature of the treatment;
determining an activity with a duration equal to the length of the travel restriction; and
suggesting the activity to the member based on the duration being equal to the length of the travel restriction.

24. The method of claim 9 further comprising:
presenting to the member a first coverage percentage associated with the first option; and
presenting to the member a second coverage percentage associated with a third option, in which the third option is for the administration of treatment within the first country, and in which the first coverage percentage is different from the second coverage percentage.

25. The method of claim 9 in which providing first details about the first option includes providing to the member a ranking associated with the first option, in which the ranking is based on at least one of: (a) feedback submitted by other members; (b) a climate in the second country; (c) a time of year; (d) a success rate for a facility to be administering the treatment in accordance with the first option; (e) a success rate for a doctor to be administering the treatment in accordance with the first option; (f) an accreditation for a facility to be administering the treatment in accordance with the first option; (g) an accreditation for a doctor to be administering the treatment in accordance with the first option; (h) an amount of experience of a doctor to be administering the treatment in accordance with the first option; (i) a measure of the hygiene of a facility to be administering the treatment in accordance with the first option; and (j) a measure of the age of equipment at a facility to be administering the treatment in accordance with the first option.

26. The method of claim 9, in which determining a medical history of the member includes receiving medical records of the member, the method further comprising:
determining a second physician to be administering treatment in accordance with the first option;
receiving authorization from the member to allow the second physician to have access to the medical records; and
providing to the second physician a representation of the medical records, in which the medical records are provided electronically.
